(19) United States
(12) Patent Application Publication
(10) Pub. No.: US 2026/0038850 A1
(43) Pub. Date: Feb. 5, 2026

(54) SEPARATOR FOR FUEL CELLS AND SEPARATOR ASSEMBLY INCLUDING THE SAME

(71) Applicants: Hyundai Motor Company, Seoul (KR); Kia Corporation, Seoul (KR)

(72) Inventors: Sun Do Shin, Hwaseong-si (KR); Woo Chul Shin, Hwaseong-si (KR); Kwang Hyun Yu, Hwaseong-si (KR)

(21) Appl. No.: 18/923,964

(22) Filed: Oct. 23, 2024

(30) Foreign Application Priority Data
Jul. 31, 2024 (KR) 10-2024-0101708

(51) Int. Cl. H01M 8/026; H01M 8/0267

(52) U.S. Cl. CPC H01M 8/026; H01M 8/0267

(57) ABSTRACT

An embodiment separator for fuel cells includes first and second diffusion sections adjacent to inlet and outlet manifolds, respectively, and a flow path region including a plurality of patterns for guiding a flow of a reaction gas, wherein the patterns include first patterns including first and second lands arranged in a first column and second patterns including third and fourth lands arranged in a second column, in a second direction perpendicular to a first direction from the first diffusion section to the second diffusion section, the first and fourth lands are arranged in a discontinuous wave type and the second and third lands are arranged in the discontinuous wave type, and a point between the first and fourth lands adjacent to each other and a point between the second and third lands adjacent to each other are offset from each other with respect to the first direction.

### CROSS-REFERENCE TO RELATED APPLICATIONS

This application claims the benefit of Korean Patent Application No. 10-2024-0101708, filed on Jul. 31, 2024, which application is hereby incorporated herein by reference.

### TECHNICAL FIELD

The present disclosure relates to a separator for fuel cells and a separator assembly including the same.

### BACKGROUND

A fuel cell is a type of power generation device that converts the chemical energy of fuel into electrical energy by electrochemical reactions within a stack and may be used to supply electrical power to small electronic products, such as portable devices, as well as to supply industrial, household, and vehicle driving power, and areas of application of fuel cells have been gradually expanding as a high-efficiency clean energy source.

A membrane electrode assembly (MEA) is disposed at the innermost part of a fuel cell stack. The membrane electrode assembly includes a polymer electrolyte membrane configured to move protons and catalyst layers applied to both surfaces of the electrolyte membrane so that hydrogen and oxygen may react therewith, i.e., an anode and a cathode.

Gas diffusion layers (GDLs) are stacked on the outer parts of the membrane electrode assembly, i.e., the outer parts of the membrane electrode assembly provided with the anode and the cathode, separators having flow fields formed to supply fuel and discharge water generated by reactions are disposed outside the gas diffusion layers, and end plates configured to support and fix the above-described components are combined with the outermost parts of the membrane electrode assembly. In order to maintain airtightness of reaction gases and a coolant flowing in the separators, gaskets are disposed on the separators in various forms.

The separators are generally manufactured with a structure in which lands serving as supports and flow paths (channels) serving as the flow passages of fluid are repeatedly formed. The lands and the flow paths are alternately arranged to form a curved flow field. The flow paths on one surface of the separator facing the gas diffusion layer are used as spaces in which the reaction gas, such as hydrogen or air, flows, and the flow paths on the other surface of the separator are used as spaces in which a cooling medium, such as the coolant, flows.

The separators maintain the shape of the fuel cell stack by electrically connecting and supporting the membrane electrode assembly while preventing hydrogen and oxygen, which are reaction gases, from mixing with each other. On a general separator, lands are formed in a straight line in the flow direction of the reaction gas. In the case of the separator with straight flow paths formed thereon, the pressure drop of the reaction gas may be reduced to improve flow efficiency. However, reaction efficiency is lowered because the flow rate of the reaction gas is too fast. Therefore, as illustrated in FIG. 1, curved lands 20 are applied to a separator 10 to form wave-type flow paths 30. Each of a plurality of flow paths 30 extends in the longitudinal direction while forming trough portions and peak portions alternately. In the case of the separator 10 with the wave-type flow paths 30, reaction efficiency may be increased by an intentional pressure drop, and uniformity of power generation by the fuel cell stack may be increased.

However, in the case of the reaction gas supplied through a diffusion part of the separator 10, a distribution deviation of the reaction gas flowing into the flow paths 30 due to a distance between a manifold and each of the flow paths 30, the shape of the flow paths 30 forming the diffusion part, etc. during a process of flowing into each flow path 30. Further, a problem in which product water 5, generated by the power generation by the fuel cell stack, accumulates in the trough portions where the phase of the wave-type flow paths 30 is the minimum arises. The performance of the fuel cell stack is deteriorated due to the distribution deviation among the flow paths 30 and the accumulation of the product water 5 in the flow paths 30. Particularly, when an outdoor temperature is below zero, freezing damage to fuel cells occurs due to moisture accumulated in the flow paths 30.

### SUMMARY

The present disclosure relates to a separator for fuel cells and a separator assembly including the same. Particular embodiments relate to a separator for fuel cells including wave-type flow paths formed by a plurality of patterns spaced apart from each other and a separator assembly including the same.

Embodiments of the present disclosure can solve problems associated with the prior art, and an embodiment of the present disclosure provides a separator for fuel cells and a separator assembly including the same that may improve the flow distribution performance of a reaction gas through discontinuous wave-type flow paths and prevent deterioration of durability of a fuel cell stack due to accumulation of product water in the flow paths.

Another embodiment of the present disclosure provides a separator for fuel cells and a separator assembly including the same that may improve the flow distribution performance of a reaction gas through flow disturbance and separation occurring at each branch point in which a flow path branches off through discontinuous wave-type flow paths.

One embodiment of the present disclosure provides a separator for fuel cells including a first diffusion section adjacent to an inlet manifold, which is a passage into which a reaction gas flows, a second diffusion section adjacent to an outlet manifold, which is a passage from which the reaction gas is discharged, and a flow path region including a plurality of patterns configured to guide the flow of the reaction gas between the first diffusion section and the second diffusion section, wherein the plurality of patterns include first patterns including first lands and second lands arranged in a first column and second patterns including third lands and fourth lands arranged in a second column different from the first column, in a second direction perpendicular to a first direction from the first diffusion section to the second diffusion section, the first lands and the fourth lands are arranged in a discontinuous wave type, the second lands and the third lands are arranged in a discontinuous wave type, and a point between the first land and the fourth land adjacent to each other and a point between the second land and the third land adjacent to each other are offset from each other with respect to the first direction.

In a preferred embodiment, the first patterns may be inclined upward with respect to the first direction, and the second patterns may be inclined downward with respect to the first direction.

In another preferred embodiment, a first column configured such that the first patterns are arranged continuously and a second column configured such that the second patterns are arranged continuously may be provided in the second direction, and the first column and the second column may be arranged alternately in the first direction.

In still another preferred embodiment, a length of each of a plurality of the first lands, a plurality of the second lands, a plurality of the third lands, and a plurality of the fourth lands arranged in a specific column may be the same.

In yet another preferred embodiment, lengths of the first lands, the second lands, the third lands, and the fourth lands may increase as they approach the second diffusion section from the first diffusion section in the first direction.

In still yet another preferred embodiment, lengths of the first lands, the second lands, the third lands, and the fourth lands may be all the same.

In a further preferred embodiment, an end of each of the first lands may be arranged between two third lands adjacent to each other in the second direction.

In another further preferred embodiment, an end of each of the third lands may be arranged between two first lands adjacent to each other in the second direction.

In still another further preferred embodiment, the first patterns may be inclined upward with respect to the first direction, the second patterns may be inclined downward with respect to the first direction, each of the fourth lands may be arranged between the third lands adjacent to each other, and a first spacing between the third land arranged above the fourth land and the fourth land may be greater than a second spacing between the third land arranged below the fourth land and the fourth land.

In yet another further preferred embodiment, angles formed by the first patterns and the second patterns with respect to the first direction may increase as they approach the second diffusion section from the first diffusion section in the first direction.

In still yet another further preferred embodiment, lengths of the first patterns and the second patterns may increase as they approach the second diffusion section from the first diffusion section in the first direction, and angles formed by the first patterns and the second patterns with respect to the first direction may increase as they approach the second diffusion section from the first diffusion section in the first direction.

In a still further preferred embodiment, columns in which the first patterns or the second patterns are arranged continuously may be provided in the second direction, and angles formed by the first patterns or the second patterns with respect to the first direction may increase as they approach an upper end from a lower end of the flow path region.

Another embodiment of the present disclosure provides a separator for fuel cells including a first diffusion section adjacent to an inlet manifold, which is a passage into which a reaction gas flows, a second diffusion section adjacent to an outlet manifold, which is a passage from which the reaction gas is discharged, and a flow path region including a plurality of patterns disposed between the first diffusion section and the second diffusion section to guide the flow of the reaction gas, wherein the plurality of patterns include a plurality of columns spaced apart from each other in a first direction from the first diffusion section to the second diffusion section, flow paths, which are spaces between the plurality of patterns, are provided in a wave type, and as the plurality of columns are spaced apart from virtual lines configured to connect positions where a phase difference of each of the flow paths is maximum or minimum in the second direction, branch points where the flow paths branch off are spaced apart from each other.

In a preferred embodiment, at least one orifice configured to reduce cross-sectional areas of the flow paths through the reaction gas flows may be provided on the branch points where the flow paths branch off.

In another preferred embodiment, the plurality of patterns may include first patterns inclined at a first angle with respect to the first direction and second patterns inclined at a second angle with respect to the first direction, the first patterns may be arranged continuously in the second direction and the second patterns may be arranged continuously in the second direction, and the first patterns and the second patterns arranged in columns adjacent to each other may be spaced apart from each other.

In still another preferred embodiment, the first patterns may be inclined toward an upper end of the flow path region with respect to the first direction, and the second patterns may be inclined toward a lower end of the flow path region with respect to the first direction.

In yet another preferred embodiment, the branch points may be arranged on both sides of the positions where the phase difference of each of the flow paths is maximum or minimum.

In still yet another preferred embodiment, lengths of each of the patterns may increase or decrease as they approach the outlet manifold from the inlet manifold, and thus a wavelength of the flow paths increases or decreases.

In a further preferred embodiment, an angle formed by each of the patterns with respect to the first direction may increase or decrease as they approach the outlet manifold from the inlet manifold, and thus an amplitude of the flow paths determined with respect to the second direction may increase or decrease.

Yet another embodiment of the present disclosure provides a separator assembly for fuel cells including the separator for fuel cell and a cathode separator having a second cooling surface configured to face a first cooling surface of the separator, wherein the separator is an anode separator, and a plurality of first flow paths configured such that a coolant flows therethrough and formed by the patterns disposed on a reaction surface of the anode separator is disposed on the first cooling surface of the anode separator, at least one narrow path area configured to have a reduced path width is disposed on a plurality of second flow paths disposed on the second cooling surface of the cathode separator, and the at least one narrow path area overlaps a space between adjacent first flow paths spaced apart from each other in a direction in which the anode separator and the cathode separator are stacked.

Other aspects and preferred embodiments of the disclosure are discussed infra.

The above and other features of embodiments of the disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the embodiments of the present disclosure, and wherein:

FIG. 1 is a view showing wave-type flow paths of a general separator;

FIG. 2 is a view showing a separator for fuel cells according to an embodiment of the present disclosure;

FIG. 3 is a view showing a plurality of patterns formed in a flow path region of the separator for fuel cells according to an embodiment of the present disclosure;

FIG. 4 is a view showing a portion of the plurality of patterns in which the phase of flow paths is maximum according to an embodiment of the present disclosure;

FIG. 5 is a view showing a portion of the plurality of patterns in which the phase of the flow paths is minimum according to an embodiment of the present disclosure;

FIG. 6 is a view for explaining a spacing between lands forming the plurality of patterns according to an embodiment of the present disclosure;

FIGS. 7 to 11 are views showing modifications of the plurality of patterns formed in the flow path region of the separator according to an embodiment of the present disclosure;

FIGS. 12A to 12C are views showing orifices disposed on flow paths according to an embodiment of the present disclosure;

FIG. 13A is a view showing a cooling surface of an anode separator according to an embodiment of the present disclosure; and

FIG. 13B is a view showing a cooling surface of a cathode separator according to an embodiment of the present disclosure.

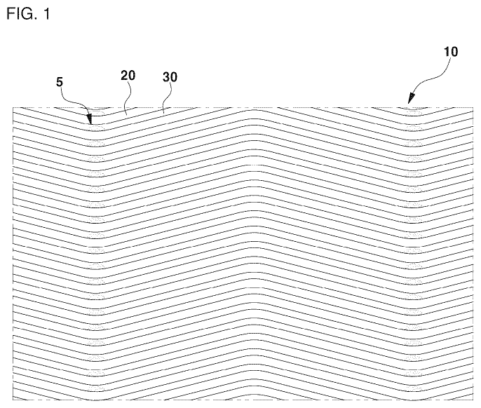

It should be understood that the appended drawings are not necessarily to scale, presenting a somewhat simplified representation of various preferred features illustrative of the basic principles of embodiments of the disclosure. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts throughout the several figures of the drawings.

### DETAILED DESCRIPTION OF ILLUSTRATIVE EMBODIMENTS

Advantages and features of embodiments of the present disclosure and methods for achieving the same will become apparent from the descriptions of the embodiments hereinbelow with reference to the accompanying drawings. However, the embodiments of the present disclosure are not limited to the embodiments disclosed herein and may be implemented in various different forms, and these embodiments are provided to make the description of the present disclosure thorough and to fully convey the scope of the embodiments of the present disclosure to those skilled in the art. It is to be noted that the scope of the embodiments of the present disclosure is defined only by the claims. In the following description of the embodiments, the same or similar elements are denoted by the same reference numerals even though they are depicted in different drawings.

In addition, in the following description of the embodiments, terms, such as “first” and “second,” are used only to distinguish various elements from each other because the names of the elements are the same, and they do not imply a sequence or order unless clearly indicated by the context.

The detailed description is illustrative of embodiments of the present disclosure. Further, the detailed description is intended to illustrate exemplary embodiments of the present disclosure, and the embodiments of the present disclosure may be used in various other combinations, modifications, and environments. That is, changes or modifications can be made within the scope of the embodiments of the disclosure disclosed in the description, a scope equivalent to the disclosed content, and/or the scope of technology or knowledge in the art. The following embodiments illustrate the best mode for implementing the technical idea of embodiments of the present disclosure, and various changes required for specific application fields and uses of the embodiments of the present disclosure are also possible. Accordingly, the following detailed description of embodiments of the present disclosure is not intended to limit the embodiments of the disclosure to the disclosed embodiments. Additionally, the appended claims should be construed to include other embodiments.

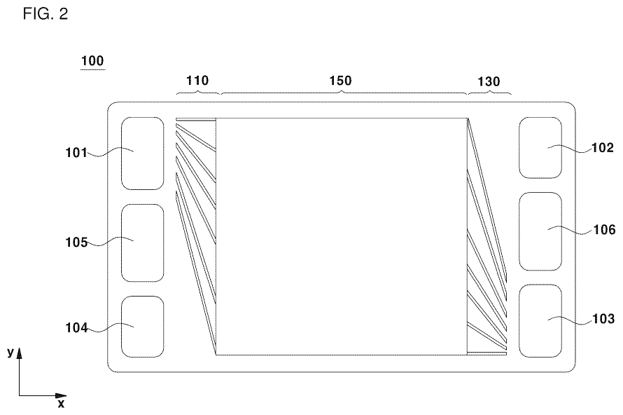

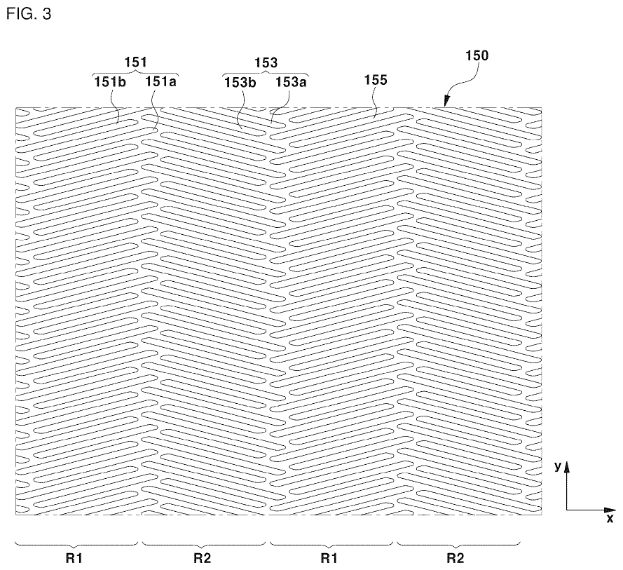

FIG. 2 is a view showing a separator for fuel cells according to an embodiment of the present disclosure, and FIG. 3 is a view showing a plurality of patterns formed in a flow path region of the separator for fuel cells according to an embodiment of the present disclosure.

Referring to FIGS. 2 and 3, a separator 100 may include manifolds 101, 102, 103, 104, 105, and 106 through which reaction gases and a coolant flow. For example, the separator 100 may be an anode separator and a cathode separator. The manifolds 101, 102, 103, 104, 105, and 106 may include inlet manifolds 101 and 102 into which the reaction gases flow, outlet manifolds 103 and 104 from which the reaction gases are discharged, and coolant manifolds 105 and 106 into and from which the coolant flows. The inlet manifolds 101 and 102 may include a first inlet manifold 101 into which hydrogen flows and a second inlet manifold 102 into which oxygen flows. The outlet manifolds 103 and 104 may include a first outlet manifold 103 from which hydrogen is discharged and a second outlet manifold 104 from which oxygen is discharged.

The separator 100 may include a first diffusion section 110 adjacent to the first inlet manifold 101, a second diffusion section 130 adjacent to the first outlet manifold 103, and a flow path region 150 disposed between the first diffusion section 110 and the second diffusion section 130. For example, the flow path region 150 may be a reaction region corresponding to a region where membrane electrode assemblies forming a fuel cell stack are stacked, but it may not be particularly limited. The flow path region 150 may be defined as a region equal to or larger than the reaction region.

The first diffusion section 110 is disposed adjacent to the first inlet manifold 101, which is a passage into which the reaction gas flows, and may diffuse the reaction gas to the flow path region 150. That is to say, the first diffusion section 110 may distribute the reaction gas introduced through the first inlet manifold 101 to the flow path region 150.

The second diffusion section 130 is disposed adjacent to the first outlet manifold 103, which is a passage through which the reaction gas is discharged, and may cause the reaction gas introduced from the flow path region 150 to flow into the first outlet manifold 103.

The flow path region 150 may include flow paths 155 through which the reaction gas or the coolant flows and a plurality of patterns 151 and 153 configured to form the flow paths 155. The flow paths 155 may be formed in a wave type, and as the plurality of patterns 151 and 153 arranged in a first direction x are spaced apart from each other, the flow paths 155 may be formed in a discontinuous wave type having a plurality of branch points. The first direction x may refer to a direction from the first diffusion section 110 to the second diffusion section 130. In addition, the first direction x may refer to a direction from the upstream to the downstream of the flow paths 155. Positions where the phase difference of each of the flow paths 155 is maximum or minimum may be spaced apart from the branch point from which one flow path 155 branches off. That is, an imbalance in flow distribution that may occur because the positions where the phase difference of each of the flow paths 155 is maximum or minimum are the same as the branch points from which the flow paths 155 branch off may be resolved. In order to cause the positions where the phase difference of each of the flow paths 155 is maximum or minimum to be different from the branch points from which the flow paths 155 branch off, the ends of the plurality of adjacent patterns 151 and 153 may overlap each other in a second direction y perpendicular to the first direction x.

The plurality of patterns 151 and 153 may be arranged in a plurality of columns R1 and R2 in the second direction y. The second direction y may be the vertical direction of the separator 100. That is, the second direction y may be a direction in which the first inlet manifold 101 and the second outlet manifold 103 are arranged. The plurality of patterns 151 and 153 may include first patterns 151 and second patterns 153. Either the first patterns 151 or the second patterns 153 may be arranged in one column R1 or R2, and each of the plurality of columns R1 and R2 may include a plurality of first patterns 151 or a plurality of second patterns 153. For example, a plurality of first patterns 151 may be arranged in the first column R1, and a plurality of second patterns 153 may be arranged in the second column R2. The first columns R1 and the second columns R2 may be arranged alternately in the first direction x. The ends of the first patterns 151 and the second patterns 153 arranged in the first column R1 and the second column R2 adjacent to each other may overlap in the second direction y, but they may be spaced apart from each other without contacting each other.

The first patterns 151 may include first lands 151a and second lands 151b that are inclined in one direction to form an acute angle with respect to the first direction x from the first diffusion section 110 to the second diffusion section 130. The second patterns 153 may include third lands 153a and fourth lands 153b that are inclined in a different direction from the first land 151a and the second land 151b to form an acute angle with respect to the first direction x. That is, the first patterns 151 may be inclined upward with respect to the first direction x, and the second patterns 153 may be inclined downward with respect to the first direction x. The meaning that the first patterns 151 and the second patterns 153 form an angle with respect to the first direction x may indicate that the extending directions of the first patterns 151 and the second patterns 153 form an angle with a virtual line extending in the first direction x. The extending directions of the first patterns 151 and the second patterns 153 may mean directions in which the longest sides of the sides forming the lands 151a, 151b, 153a, and 153b or the major axes thereof, which are formed in various shapes, such as a rectangle, a trapezoid, and an ellipse, extend. In other words, the first patterns 151 may form an acute angle upward with respect to the virtual line extending in the first direction x, and the second patterns 153 may form an acute angle downward with respect to the virtual line extending in the first direction x. The upward or downward direction may be determined based on the second direction y, which is the vertical direction. The length of each of the plurality of first lands 151a arranged in the second direction y may be the same, the length of each of the plurality of second lands 151b arranged in the second direction y may be the same, the length of each of the plurality of third lands 153a arranged in the second direction y may be the same, and the length of each of the plurality of first lands 153b arranged in the second direction y may be the same.

The plurality of first lands 151a and the plurality of second lands 151b may be arranged alternately in the second direction y. For example, the first lands 151a and the second lands 151b may extend to the same length. However, the first lands 151a and the second lands 151b may have different lengths. Both ends of the first lands 151a and the second lands 151b may not coincide with each other with respect to the first direction x. That is, the first lands 151a and the second lands 151b may be arranged to be misaligned from each other in the second direction y.

The plurality of third lands 153a and the plurality of fourth lands 153b may be arranged alternately in the second direction y. For example, the third lands 153a and the fourth lands 153b may extend to different lengths, and the length of the third lands 153a may be longer than the length of the fourth lands 153b. However, the third lands 153a and the fourth lands 153b may have the same length. Both ends of the third lands 153a and the fourth lands 153b may not coincide with each other with respect to the first direction x. The fourth lands 153b may be arranged such that both ends thereof do not protrude beyond both ends of the third lands 153a in the first direction x.

The first lands 151a and the fourth lands 153b may be arranged in a discontinuous wave type, and the second lands 151b and the third lands 153a may be arranged in a discontinuous wave type. Here, a point between the first land 151a and the fourth land 153b adjacent to each other and a point between the second land 151b and the third land 153a adjacent to each other may be arranged offset from each other with respect to the first direction x. That is, a point between the end of the first land 151a and the end of the fourth land 153b facing each other and a point between the end of the second land 151b and the end of the third land 153a facing each other may be arranged in a zigzag manner in the second direction y.

The left end of each of the first lands 151a, the second lands 151b, the third lands 153a, and the fourth lands 153b in the first direction x may be defined as a first end, and the right end of each of the first lands 151a, the second lands 151b, the third lands 153a, and the fourth lands 153b in the first direction x may be defined as a second end. The second end of one first land 151a may be arranged between two third lands 153a adjacent to each other in the second direction y. That is, the second end of one first land 151a may protrude to a space between the first ends of two third lands 153a adjacent to each other in the second direction y. The first end of one third land 153a may be arranged between two first lands 151a adjacent to each other in the second direction y. That is, the first end of one third land 153a may protrude to a space between the second ends of two first lands 151a adjacent to each other in the second direction y. The first end of one second land 151b may be arranged between the ends of two third lands 153a adjacent to each other in the second direction y. That is, the first end of one second land 151b may protrude to a space between the ends of two third lands 153a adjacent to each other in the second direction y. The fourth lands 153b extend to a shorter length than the first lands 151a, the second lands 151b, and the third lands 153a, and one fourth land 153b is arranged between the second end of one first land 151a and the first end of one second land 151b.

In the second direction y, the second ends of the first lands 151a and the first ends of the third lands 153a may be arranged alternately, and the second ends of the third lands 153a and the first ends of the second lands 151b may be arranged alternately.

The reaction gas flowing in the first direction x along one of the flow paths 155 arranged in a specific column among the columns R1 and R2 may be distributed and introduced into two flow paths 155 by the patterns 151 or 153 arranged in another column adjacent to the specific column. That is, each of the flow paths 155 may be a discontinuous flow path by the patterns 151 and 153 spaced apart from each other, and the reaction gas flowing through the specific flow path 155 may be distributed to two flow paths 155 at a discontinuous point.

According to an embodiment of the present disclosure, the first patterns 151 and the second patterns 153 for forming the flow paths 155 are arranged to be spaced apart from each other such that the ends of the first patterns 151 and the second patterns 153 adjacent to each other are arranged alternately in the second direction y, and a plurality of branch points generated may not coincide with each other due to the plurality of patterns 151 and 153 that are spaced apart from the positions where the phase difference of the flow paths 155 is maximum or minimum. Therefore, flow distribution of the reaction gas or the coolant flowing through the flow paths 155 may be uniform.

According to an embodiment of the present disclosure, since the flow paths 155 are in the discontinuous wave type, it is possible to prevent product water from accumulating in the trough portions of waveforms.

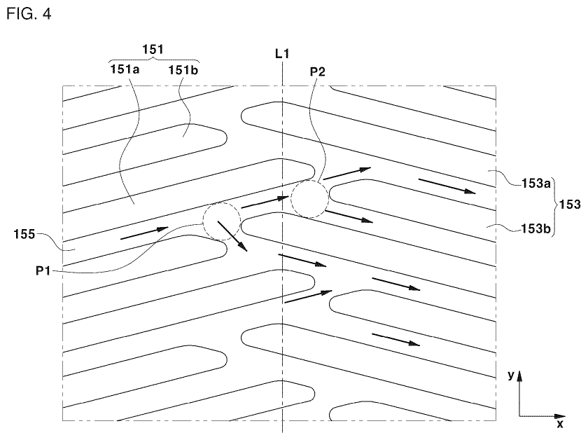

FIG. 4 is a view showing a portion of the plurality of patterns in which the phase of flow paths is maximum according to an embodiment of the present disclosure.

Referring to FIGS. 2 and 4, due to the plurality of patterns 151 and 153 spaced apart from each other and arranged such that both ends thereof intersect each other, branch points P1 and P2, where the reaction gas branches, may be created on the flow paths 155. The branch points P1 and P2 where the reaction gas branches may include first branch points P1 and second branch points P2. The first branch point P1 may be created on the flow path 155 between the first land 151a, arranged above the second land 151b among two adjacent first lands 151a, and the corresponding second land 151b. The first branch point P1 may be created on the flow path 155 among the first land 151a, the second land 151b, and the third land 153a. The second branch point P2 may be created on the flow path 155 between the third land 153a, arranged below the fourth land 154b among two adjacent third lands 153a, and the corresponding fourth land 154b. The second branch point P2 may be created on the flow path 155 among the second land 151b, the third land 153a, and the fourth land 153b. Based on the positions of the coolant manifolds 105 and 106, a position where the first inlet manifold 101 is arranged may be the upper end of the separator, and a position where the first outlet manifold 103 is arranged may be the lower end of the separator.

As the plurality of columns or the plurality of patterns 151 and 153 is spaced apart from a first virtual line L1 that connects the positions where the phase difference of each of the flow paths 155 is maximum in the second direction y, the branch points P1 and P2 where the flow paths 155 branch may be spaced apart from each other. That is to say, the patterns 151 and 153 may be arranged such that the branch points P1 and P2 where the flow paths 155 branch off may be arranged offset with respect to the first virtual line L1 and the first direction x.

The first branch points P1 and the second branch points P2 are arranged in a zigzag manner with respect to the first virtual line L1. The first branch point P1 and the second branch point P2 may be arranged on both sides of the position of the point where the phase difference of each of the flow paths 155 is maximum, and the first branch point P1 and the second branch point P2 may be arranged at different heights in the second direction y. That is, the first branch points P1 and the second branch points P2 are arranged alternately on the left and right sides of the positions of the points where the phase difference of the respective flow paths 155 is maximum.

Unlike the above-described example, the positions of the branch points P1 and P2 where the flow paths 155 branch off may vary depending on the length of each of the lands 151a, 151b, 153a, and 153b forming the patterns 151 and 153, but the positions of the branch points P1 and P2 where the flow paths 155 branch off may differ from the positions of the peak portions of the waveforms due to the shape of the flow paths 155.

According to an embodiment of the present disclosure, since the positions of the peak portions where the phase difference of the waveforms of the flow paths 155 is maximum and the positions of the branch points P1 and P2 where the flow paths branch off are different from each other, the reaction gas may be distributed through the branch points P1 and P2 before reaching the peak portions of the flow paths 155 or after passing the peak portions. Therefore, the flow distribution performance of the reaction gas may be improved.

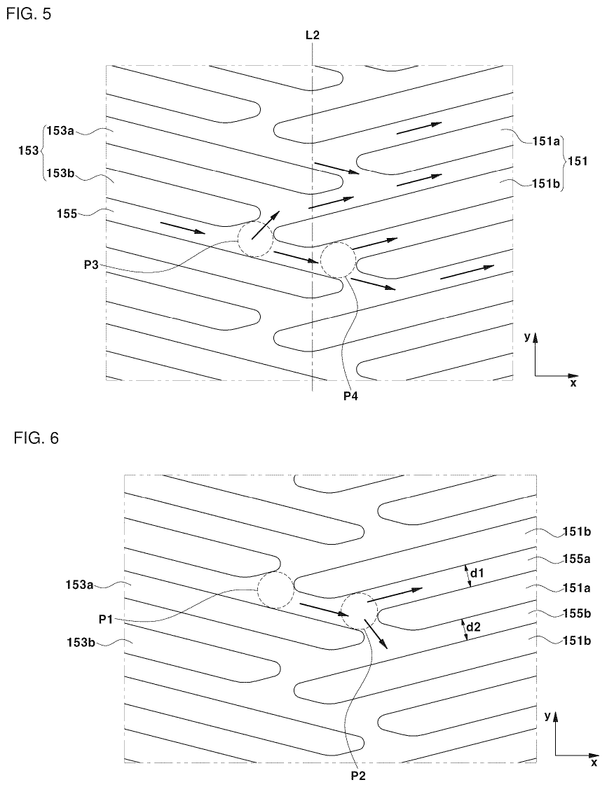

FIG. 5 is a view showing a portion of the plurality of patterns in which the phase of the flow paths is minimum according to an embodiment of the present disclosure.

Referring to FIGS. 2 and 5, due to the plurality of patterns 151 and 153 spaced apart from each other and arranged such that both ends of the plurality of patterns 151 and 153 intersect each other, branch points P3 and P4 where the reaction gas branches may be created on the flow paths 155. The branch points P3 and P4 where the reaction gas branches may include third branch points P3 and fourth branch points P4. The third branch point P3 may be created on the flow path 155 between the third land 153a, arranged below the fourth land 153b among two adjacent third lands 153a, and the corresponding fourth land 153b. The third branch point P3 may be created on the flow path 155 among the second land 151b, the third land 153a, and the fourth land 153b. The fourth branch point P2 may be created on the flow path 155 between the second land 151b, arranged above the first land 151a among two adjacent second lands 151b, and the corresponding first land 151a. The fourth branch point P4 may be created on the flow path 155 among the first land 151a, the second land 151b, and the third land 153a.

As the plurality of columns or the plurality of patterns 151 and 153 is spaced apart from a second virtual line L2 that connects the positions where the phase difference of each of the flow paths 155 is minimum in the second direction y, the branch points P3 and P4 where the flow paths 155 branch off may be spaced apart from each other. That is, the patterns 151 and 153 may be arranged such that the branch points P3 and P4 where the flow paths 155 branch off may be arranged offset with respect to the second virtual line L2 and the first direction x.

The third branch points P3 and the fourth branch points P4 are arranged in a zigzag manner with respect to the second virtual line L2. The third branch point P3 and the fourth branch point P4 may be arranged on both sides of the position of the point where the phase difference of each of the flow paths 155 is minimum, and the third branch point P3 and the fourth branch point P4 may be arranged at different heights in the second direction y. That is, the third branch points P3 and the fourth branch points P4 are arranged alternately on the left and right sides of the positions of the points where the phase difference of the respective flow paths 155 is minimum.

Unlike the above-described example, the positions of the branch points P3 and P4 where the flow paths 155 branch off may vary depending on the length of each of the lands 151a, 151b, 153a, and 153b forming the patterns 151 and 153, but the positions of the branch points P3 and P4 where the flow paths 155 branch off may differ from the positions of the trough portions of the waveforms due to the shape of the flow paths 155.

According to an embodiment of the present disclosure, since the positions of the trough portions where the phase difference of the wave-type flow paths 155 is minimum and the positions of the branch points P3 and P4 where the flow paths branch off are different from each other, the reaction gas may be distributed through the branch points P3 and P4 before reaching the trough portions of the flow paths 155 or after passing the trough portions. Therefore, the flow distribution performance of the reaction gas may be improved.

FIG. 6 is a view for explaining a spacing between the lands forming the plurality of patterns according to an embodiment of the present disclosure.

Referring to FIG. 6, the third lands 153a and the fourth lands 153b may extend while being inclined downward with respect to the first direction x. The reaction gas may branch at the trough portions of the flow paths 155a and 155b, and the reaction gas guided through the third lands 153a and the fourth lands 153b extending downward may flow at a greater flow rate in the same direction as the moving direction of the reaction gas. Therefore, the flow distribution performance may become uniform at the second branch point P2 by adjusting the widths of the two flow paths 155a and 155b branched off at the second branch point P2. The second branch point P2 may be a branch point defined between the first land 151a, the second land 151b, and the third land 153a. For example, the width d1 of the first flow path 155a that meets the reaction gas branched upward from the second branch point P2 may be greater than or equal to the width d2 of the second flow path 155b that meets the reaction gas branched downward from the fourth branch point P4. Both the first flow path 155a and the second flow path 155b are flow paths that extend upward, but the first flow path 155a may be located above the first land 151a and the second flow path 155b may be located below the first land 151a. That is, considering that a greater amount of a fluid flows in the direction in which the fluid is moving, the width d1 of the first flow path 155a located in a different direction from the direction in which the fluid is moving may be greater than or equal to the width d2 of the second flow path 155b located in the same direction as the direction in which the fluid is moving. Accordingly, the flow distribution performance at the branch point where the reaction gas branches becomes uniform.

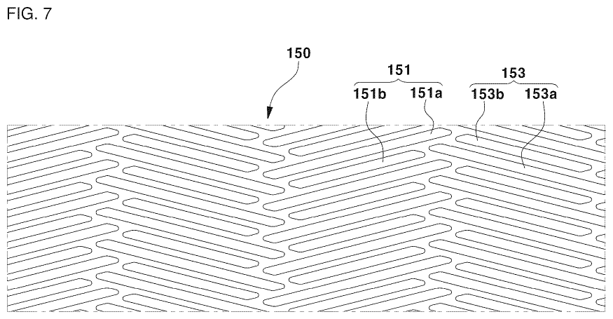

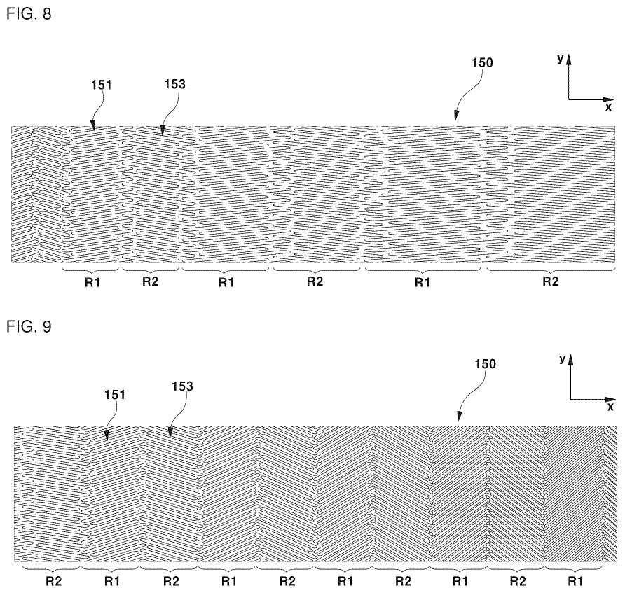

FIGS. 7 to 11 are views showing modifications of the plurality of patterns formed in the flow path region of the separator according to an embodiment of the present disclosure. The lengths of the lands forming the patterns illustrated in FIGS. 8 to 10 may be the same as the lengths of the lands forming the patterns illustrated in FIG. 7.

Referring to FIG. 7, the lengths of the first lands 151a and the second lands 151b forming the first patterns 151 arranged in the flow path region 150 may be different from each other. The lengths of the third lands 153a and the fourth lands 153b forming the second patterns 153 arranged in the flow path region 150 may be different from each other. Specifically, the first lands 151a may be longer than the second lands 151b, and the third lands 153a may be longer than the fourth lands 153b. In the second direction in which the first patterns 151 or the second patterns 153 are arranged continuously, the first lands 151a and the second lands 151b may be arranged alternately, and the third lands 153a and the fourth lands 153b may be arranged alternately.

The end of one first land 151a having a relatively long length may be arranged in a space between two third lands 153a arranged in an adjacent column, and the end of one third land 153a having a relatively long length may be arranged in a space between two first lands 151a arranged in an adjacent column. With respect to the first direction, both ends of the second lands 151b may not protrude beyond both ends of the first lands 151a, and both ends of the fourth lands 153b may not protrude beyond both ends of the third lands 153a.

Referring to FIGS. 2 and 8, the first lands 151a, the second lands 151b, the third lands 153a, and the fourth lands 153b may become longer as they approach the first outlet manifold 103 from the first inlet manifold 101 in the first direction x. However, the lengths of the plurality of first lands 151a arranged in each of the first columns R1 may be the same, the lengths of the plurality of second lands 151b arranged in each of the first columns R1 may be the same, the lengths of the plurality of third lands 153a arranged in each of the second columns R2 may be the same, and the lengths of the plurality of fourth lands 153b arranged in each of the second columns R2 may be the same. That is, the length of each of the first lands 151a, the second lands 151b, the third lands 153a, and the fourth lands 153b arranged in a specific column placed upstream in the first direction x may be shorter than the length of a corresponding one of the first lands 151a, the second lands 151b, the third lands 153a, and the fourth lands 153b arranged in a specific column placed downstream in the first direction x.

The length of each of the lands 151a, 151b, 153a, and 153b or the length of each of the patterns 151 and 153 increases as they approach the first outlet manifold 103 from the first inlet manifold 101 in the first direction x, and thereby, the wavelength of the flow paths may increase.

Unlike the above-described example, the length of each of the lands 151a, 151b, 153a, and 153b or the length of each of the patterns 151 and 153 decreases as they approach the first outlet manifold 103 from the first inlet manifold 101 in the first direction x, and thereby, the wavelength of the flow paths may decrease.

Referring to FIGS. 2 and 9, an angle formed by each of the first lands 151a, the second lands 151b, the third lands 153a, and the fourth lands 153b with respect to the first direction x may increase as they approach the first outlet manifold 103 from the first inlet manifold 101 in the first direction x. However, the angles formed by the plurality of first lands 151a arranged in each of the first columns R1 with respect to the first direction x may be the same, the angles formed by the plurality of second lands 151b arranged in each of the first columns R1 with respect to the first direction x may be the same, the angles formed by the plurality of third lands 153a arranged in each of the second columns R2 with respect to the first direction x may be the same, and the angles formed by the plurality of fourth lands 153b arranged in each of the second columns R2 with respect to the first direction x may be the same. That is, the angle of each of the first lands 151a, the second lands 151b, the third lands 153a, and the fourth lands 153b, arranged in a specific column placed upstream in the first direction x, with the first direction x may be smaller than the angle of a corresponding one of the first lands 151a, the second lands 151b, the third lands 153a, and the fourth lands 153b, arranged in a specific column placed downstream in the first direction x, with the first direction x.

The angle formed by each of the lands 151a, 151b, 153a, and 153b or an angle formed by each of the patterns 151 and 153 with respect to the first direction x or the angle formed by each of the patterns 151 and 153 with respect to the first direction increases as they approach the first outlet manifold 103 from the first inlet manifold 101 in the first direction x, and thereby, the amplitude of the flow paths may increase.

Unlike the above-described example, the angle formed by each of the lands 151a, 151b, 153a, and 153b or the angle formed by each of the patterns 151 and 153 with respect to the first direction x or the angle formed by each of the patterns 151 and 153 with respect to the first direction decreases as they approach the first outlet manifold 103 from the first inlet manifold 101 in the first direction x, and thereby, the amplitude of the flow paths may decrease.

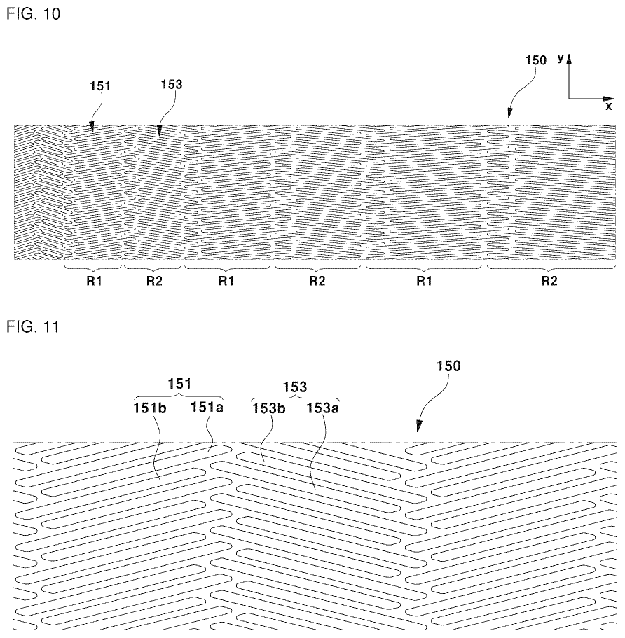

Referring to FIGS. 2 and 10, the angle formed by the plurality of first lands 151a arranged in each of the first columns R1 with respect to the first direction x and the length of each of the plurality of first lands 151a may be the same. The angle formed by the plurality of second lands 151b arranged in each of the first columns R1 with respect to the first direction x and the length of each of the plurality of second lands 151b may be the same. The angle formed by the plurality of third lands 153a arranged in each of the second columns R2 with respect to the first direction x and the length of each of the plurality of third lands 153a may be the same. The angle formed by the plurality of fourth lands 153b arranged in each of the second columns R2 with respect to the first direction x and the length of each of the plurality of fourth lands 153b may be the same. However, the angle formed by each of the first lands 151a, the second lands 151b, the third lands 153a, and the fourth lands 153b with respect to the first direction x may increase as they approach the first outlet manifold 103 from the first inlet manifold 101 in the first direction x. In addition, the length of each of the first lands 151a, the second lands 151b, the third lands 153a, and the fourth lands 153b may increase as they approach the first outlet manifold 103 from the first inlet manifold 101 in the first direction x.

The angle formed by each of the first lands 151a, the second lands 151b, the third lands 153a, and the fourth lands 153b with respect to the first direction x or the angle formed by each of the patterns 151 and 153 with respect to the first direction x may increase as they approach the first outlet manifold 103 from the first inlet manifold 101 in the first direction x, and thereby, the amplitude of the flow paths may increase. In addition, the length of each of the lands 151a, 151b, 153a, and 153b or the length of each of the patterns 151 and 153 may increase as they approach the first outlet manifold 103 from the first inlet manifold 101 in the first direction x, and thereby, the wavelength of the flow paths may increase.

Unlike the above-described example, the amplitude of the flow paths may decrease and the wavelength of the flow paths may decrease as the lands 151a, 151b, 153a, and 153b approach the first outlet manifold 103 from the first inlet manifold 101 in the first direction x.

Referring to FIG. 11, the length of each of the plurality of first lands 151a arranged in the second direction y may be the same, the length of each of the plurality of second lands 151b arranged in the second direction y may be the same, the length of each of the plurality of third lands 153a arranged in the second direction y may be the same, and the length of each of the plurality of fourth lands 153b arranged in the second direction y may be the same. In addition, the lengths of the first lands 151a, the second lands 151b, the third lands 153a, and the fourth lands 153b may be the same. However, the centers of the first lands 151a and the second lands 151b arranged together in one column may not coincide with each other with respect to the first direction x. That is, the first lands 151a and the second lands 151b arranged alternately in the second direction y in one column may be arranged to be misaligned from each other in the first direction x. However, both ends of the plurality of first lands 151a or both ends of the plurality of second lands 151b may coincide with each other in the first direction x. In addition, the centers of the third lands 153a and the fourth lands 153b arranged together in one column may not coincide with each other with respect to the first direction x. That is, the third lands 153a and the fourth lands 153b arranged alternately in the second direction y in one column may be arranged to be misaligned from each other in the first direction x. However, both ends of the plurality of third lands 153a or both ends of the plurality of fourth lands 153b may coincide with each other in the first direction x.

The end of one first land 151a may be arranged in a space between two adjacent third lands 153a arranged in an adjacent column, and the end of one third land 153a may be arranged in a space between two adjacent first lands 151a arranged in an adjacent column.

The various forms of the arrangement of the patterns 151 and 153 may serve to prevent accumulation of product water in the trough portions of the flow paths.

Unlike the above-described example, the angle formed by the lands 151a, 151b, 153a, or 153b, arranged in one column R1 or R2 among the plurality of columns R1 and R2, with respect to the first direction x may increase as they approach the top in the second direction y. Here, the wavelength of the flow paths may be constant throughout the entire region.

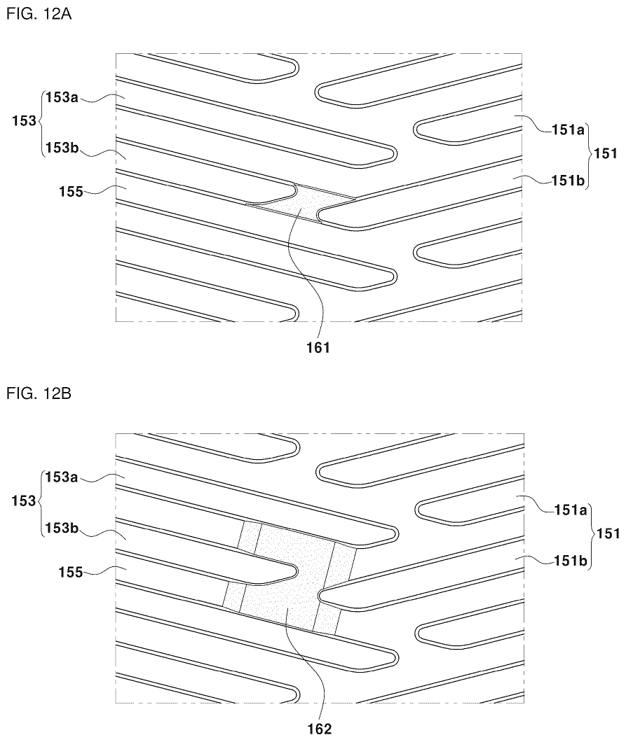

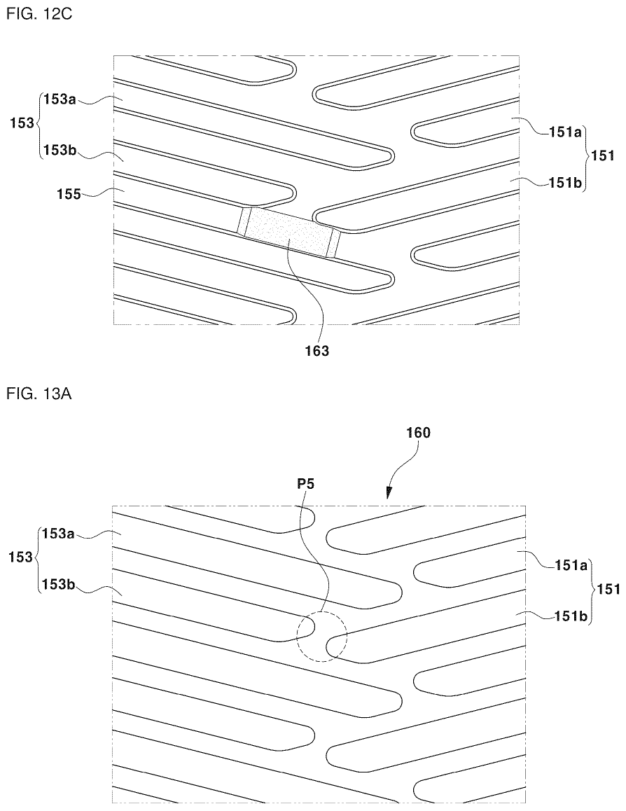

FIGS. 12A to 12C are views showing orifices disposed on the flow paths according to an embodiment of the present disclosure.

Referring to FIGS. 12A to 12C, an orifice 161, 162, or 163 may be arranged at at least one of the plurality of branch points where the flow paths 155 branch off. The branch points may mean branch points where a specific flow path 155 branches off into two flow paths 155. Therefore, at least one orifice 161, 162, or 163 may be disposed on one separator.

The orifices 161, 162, and 163 may be arranged at branch points where the flow paths 155 branch off to reduce the cross-sectional area of the flow paths 155 through which the reaction gas flows. That is, the orifice 161, 162, or 163 does not completely block the flow path 155 and blocks only a part of the flow path 155, thereby being capable of improving a pressure drop caused by a large amount of the reaction gas branching off to other adjacent flow paths 155 through the branch point. Therefore, the orifices 161, 162, and 163 may be manufactured in various shapes.

Referring to FIG. 12A, the orifice 161 may be arranged on a passage connecting a branch point where a specific flow path 155 branches off to an adjacent flow path 155 into which the reaction gas flowing through the specific flow path 155 flows. That is, the orifice 161 may be disposed in a space between the respective ends of one second land 151b and one fourth land 153b facing each other. The second land 151b may be configured to protrude into a space between two adjacent third lands 153a.

Referring to FIG. 12B, the orifice 162 may be arranged on a passage connecting a branch point where a specific flow path 155 branches off to an adjacent flow path 155 into which the reaction gas flowing through the specific flow path 155 flows and on a region adjacent thereto. That is, the orifice 162 may be disposed in a wider area than the orifice 161.

Referring to FIG. 12C, the orifice 163 may be arranged on a branch point where a specific flow path 155 branches off. The amount of the reaction gas branching downward at the branch point through the specific flow path 155 is reduced by the orifice 163, and thus the amount of the reaction gas flowing upward at the branch point may be increased.

In order to improve distribution performance at a specific position in the flow analysis of the reaction gas, the orifice 161, 162, or 163 may be arranged. The specific position and shape of the orifice 161, 162, or 163 may vary depending on various methods of improving the distribution performance.

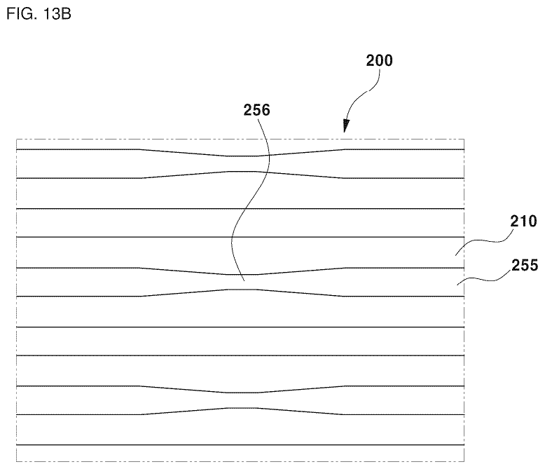

FIG. 13A is a view showing a cooling surface of an anode separator according to an embodiment of the present disclosure, and FIG. 13B is a view showing a cooling surface of a cathode separator according to an embodiment of the present disclosure.

Referring to FIG. 13A, a separator having a plurality of patterns 151 and 153 arranged thereon may be an anode separator. For example, the separator 100 shown in FIG. 2 may be an anode separator. The plurality of patterns 151 and 153 may be provided to protrude from a reaction surface of the anode separator. Recessed spaces may be formed on a first cooling surface of the anode separator by the plurality of patterns 151 and 153. Based on the first cooling surface of the anode separator, the spaces recessed by the plurality of patterns 151 and 153 may be defined as first flow paths. A region of the first cooling surface of the anode separator where the first flow paths are defined may be defined as a second flow path region 160. The second flow path region 160 may mean a surface opposite to the flow path region 150 of FIG. 2. Spaces between the plurality of first flow paths spaced apart from each other may be defined as separation parts P5.

Referring to FIG. 13B, a cathode separator 200 may have a second cooling surface facing the first cooling surface of the anode separator. A plurality of cathode lands 210 configured to form a plurality of second flow paths 255 may be disposed on the second cooling surface of the cathode separator 200. At least one of the second flow paths 255 may be provided with a narrow path area 256 having a reduced path width. That is, some of the second flow paths 255 may have the narrow path area 256 having the reduced path width.

Referring to FIGS. 13A and 13B, the at least one narrow path area 256 may overlap the space between the first flow paths spaced apart from each other, in a direction in which the anode separator and the cathode separator 200 are stacked. The at least one narrow path area 256 formed on the second cooling surface of the cathode separator 200 may be disposed to overlap the separation part P5 formed on the first cooling surface of the anode separator. A space between the first cooling surface of the anode separator and the second cooling surface of the cathode separator 200 may be a space through which the coolant flows. The first flow paths, which are the spaces recessed by the plurality of patterns 151 and 153, are arranged to be spaced apart from each other. When the anode separator and the cathode separator are stacked so that the separation part P5, which is the space between the first flow paths, overlap the narrow path area 256, restriction of the flow of the coolant due to the discontinuous first flow paths may be resolved by the narrow path area 256.

As is apparent from the above description, according to an embodiment of the present disclosure, first patterns and second patterns configured to form flow paths are arranged to be spaced apart from each other and the ends of the first patterns and the second patterns adjacent to each other are arranged alternately in a second direction, and thus, a plurality of branch points generated may not coincide with each other due to a plurality of patterns that are spaced apart from positions where the phase difference of the flow paths is maximum or minimum. Therefore, flow distribution of reaction gas flowing through the flow paths may become uniform.

According to an embodiment of the present disclosure, since the flow paths are in a discontinuous wave type, accumulation of product water in trough portions of waveforms may be prevented.

According to an embodiment of the present disclosure, a pressure drop of a specific flow path caused by branch points of the flow paths may be improved through an orifice arranged in consideration of the positions of the branch points.

Embodiments of the disclosure have been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A separator for fuel cells, the separator comprising:
a first diffusion section adjacent to an inlet manifold, wherein the inlet manifold comprises a passage into which a reaction gas flows;
a second diffusion section adjacent to an outlet manifold, wherein the outlet manifold comprises a passage from which the reaction gas is discharged; and
a flow path region comprising a plurality of patterns configured to guide a flow of the reaction gas between the first diffusion section and the second diffusion section, wherein:
the plurality of patterns comprise first patterns comprising first lands and second lands arranged in a first column and second patterns comprising third lands and fourth lands arranged in a second column different from the first column, in a second direction perpendicular to a first direction from the first diffusion section to the second diffusion section;
the first lands and the fourth lands are arranged in a discontinuous wave type and the second lands and the third lands are arranged in the discontinuous wave type; and
a first point between the first land and the fourth land adjacent to each other and a second point between the second land and the third land adjacent to each other are offset from each other with respect to the first direction.

2. The separator of claim 1, wherein:
the first patterns are inclined upward with respect to the first direction; and
the second patterns are inclined downward with respect to the first direction.

3. The separator of claim 1, wherein:
the first column is configured such that the first patterns are arranged continuously and the second column is configured such that the second patterns are arranged continuously;
the first column and the second column are disposed in the second direction; and
the first column and the second column are arranged alternately in the first direction.

4. The separator of claim 3, wherein a length of each of a plurality of the first lands, a plurality of the second lands, a plurality of the third lands, and a plurality of the fourth lands arranged in a specific column is the same.

5. The separator of claim 3, wherein lengths of the first lands, the second lands, the third lands, and the fourth lands increase as they approach the second diffusion section from the first diffusion section in the first direction.

6. The separator of claim 1, wherein lengths of the first lands, the second lands, the third lands, and the fourth lands are all the same.

7. The separator of claim 1, wherein an end of each of the first lands is arranged between two third lands adjacent to each other in the second direction.

8. The separator of claim 7, wherein an end of each of the third lands is arranged between two first lands adjacent to each other in the second direction.

9. The separator of claim 7, wherein:
the first patterns are inclined upward with respect to the first direction;
the second patterns are inclined downward with respect to the first direction;
each of the fourth lands is arranged between the third lands adjacent to each other; and
a first spacing between the third land arranged above the fourth land and the fourth land is greater than a second spacing between the third land arranged below the fourth land and the fourth land.

10. The separator of claim 1, wherein angles defined by the first patterns and the second patterns with respect to the first direction increase as they approach the second diffusion section from the first diffusion section in the first direction.

11. The separator of claim 1, wherein:
lengths of the first patterns and the second patterns increase as they approach the second diffusion section from the first diffusion section in the first direction; and
angles defined by the first patterns and the second patterns with respect to the first direction increase as they approach the second diffusion section from the first diffusion section in the first direction.

12. The separator of claim 1, wherein:
columns in which the first patterns or the second patterns are arranged continuously are disposed in the second direction; and
angles defined by the first patterns or the second patterns with respect to the first direction increase as they approach an upper end from a lower end of the flow path region.

13. A separator for fuel cells, the separator comprising:
a first diffusion section adjacent to an inlet manifold, wherein the inlet manifold comprises a passage into which a reaction gas flows;
a second diffusion section adjacent to an outlet manifold, wherein the outlet manifold comprises a passage from which the reaction gas is discharged; and
a flow path region comprising a plurality of patterns disposed between the first diffusion section and the second diffusion section to guide a flow of the reaction gas, wherein:
the plurality of patterns comprise a plurality of columns spaced apart from each other in a first direction from the first diffusion section to the second diffusion section;
flow paths are disposed in a wave type, wherein the flow paths comprise spaces between the plurality of patterns; and
as the plurality of columns are spaced apart from virtual lines configured to connect positions where a phase difference of each of the flow paths is maximum or minimum in a second direction, branch points where the flow paths branch off are spaced apart from each other.

14. The separator of claim 13, wherein an orifice configured to reduce cross-sectional areas of the flow paths through which the reaction gas flows is disposed on the branch point where the flow path branches off.

15. The separator of claim 13, wherein:
the plurality of patterns comprise first patterns inclined at a first angle with respect to the first direction and second patterns inclined at a second angle with respect to the first direction;
the first patterns are arranged continuously in the second direction and the second patterns are arranged continuously in the second direction; and
the first patterns and the second patterns arranged in columns adjacent to each other are spaced apart from each other.

16. The separator of claim 15, wherein:
the first patterns are inclined toward an upper end of the flow path region with respect to the first direction; and
the second patterns are inclined toward a lower end of the flow path region with respect to the first direction.

17. The separator of claim 15, wherein the branch points are arranged on both sides of the positions where the phase difference of each of the flow paths is the maximum or the minimum.

18. The separator of claim 13, wherein lengths of each of the patterns increase or decrease as they approach the outlet manifold from the inlet manifold such that a wavelength of the flow paths increases or decreases.

19. The separator of claim 13, wherein angles defined by each of the patterns with respect to the first direction increase or decrease as they approach the outlet manifold from the inlet manifold such that an amplitude of the flow paths determined with respect to the second direction increases or decreases.

20. A separator assembly for fuel cells, the separator assembly comprising:
a separator comprising:
a first diffusion section adjacent to an inlet manifold, wherein the inlet manifold comprises a passage into which a reaction gas flows;
a second diffusion section adjacent to an outlet manifold, wherein the outlet manifold comprises a passage from which the reaction gas is discharged; and
a flow path region comprising a plurality of patterns disposed between the first diffusion section and the second diffusion section to guide a flow of the reaction gas, wherein:
the plurality of patterns comprise a plurality of columns spaced apart from each other in a first direction from the first diffusion section to the second diffusion section;
flow paths are disposed in a wave type, wherein the flow paths comprise spaces between the plurality of patterns; and
as the plurality of columns are spaced apart from virtual lines configured to connect positions where a phase difference of each of the flow paths is maximum or minimum in a second direction, branch points where the flow paths branch off are spaced apart from each other; and
a cathode separator having a second cooling surface configured to face a first cooling surface of the separator;
wherein the separator is an anode separator;
a plurality of first flow paths configured such that a coolant flows therethrough and defined by the patterns disposed on a reaction surface of the anode separator is disposed on the first cooling surface of the anode separator;
a narrow path area configured to have a reduced path width is disposed on a plurality of second flow paths disposed on the second cooling surface of the cathode separator; and
the narrow path area overlaps a space between adjacent first flow paths spaced apart from each other in a direction in which the anode separator and the cathode separator are stacked.
